(19) United States
(12) Patent Application Publication
(10) Pub. No.: US 2005/0032934 A1
(43) Pub. Date: Feb. 10, 2005

(54) Permanently plastic plasticine for fire-protection applications, methods for its preparation and its use

(76) Inventors: Herbert Muenzenberger, Wiesbaden (DE); Christian Foerg, Dillishausen (DE)

Correspondence Address: DAVID TOREN, ESQ.;SIDLEY, AUSTIN, BROWN & WOOD, LLP, 787 SEVENTH AVENUE, NEW YORK, NY, 10019-6018, US

(21) Appl. No.: 10/910,879

(22) Filed: Aug. 4, 2004

(30) Foreign Application Priority Data
Aug. 5, 2003 (DE) 103 35 808.0

(51) Int. Cl. C08K 5/49; C09K 21/14; C08K 3/38; C08K 3/40

(52) U.S. Cl. 523/179; 524/445; 524/494; 524/404; 524/115

(57) ABSTRACT

A permanently plastic Plasticine for fire-protection applications is described, comprising a matrix composition, which contains fire-protection additives and conventional auxiliary materials and is based on organic polymers, and a method for its preparation and its use for the fire-protecting sealing of openings, cable and pipe bushings in walls, floors and/or ceilings, of joints between ceiling parts and wall parts, between masonry openings and construction parts, which are to be installed, such as window frames and door frames, between ceilings and walls and between exterior walls and curtaining facades, for the purpose of thermal insulation and/or fire protection, are described.

### FIELD OF INVENTION

The object of the present invention is a permanently plastic Plasticine for fire-protection applications, comprising a matrix composition containing a fire-protection additive and conventional auxiliary materials and based on organic polymers, a method for the production of this Plasticine as well as the use of this Plasticine for sealing openings, cable and pipe bushings in walls, floors and/or ceilings of buildings, etc.

### BACKGROUND INFORMATION AND PRIOR ART

For sealing or dividing off openings, cable and pipe bushings in walls, floors and/or ceilings, joints between ceiling parts and wall parts, between masonry openings and construction parts that are to be installed, such as window and door frames, between ceilings and walls and between exterior walls and curtaining facades of buildings against fire and smoke for the purpose of thermal insulation and/or fire protection, a series of different sealing products are used, which may be present in the form of strips, panels, annular linings, etc., but also as sealing compositions or Plasticines.

The sealing compositions have an independent range of applications for bushings of plastic-insulated individual cables, bundles of cables and pipes through openings in walls, floors and/or ceilings of buildings. Very frequently, they are used in combination with other prefabricated systems, such as blocks or panels. This range of applications includes particularly the placing of communication cables through such openings, since it may happen here that the fire protection bulkhead must be opened daily and closed once again because of the constantly changing cable assignments. For this purpose, it is necessary for the sealing composition to remain constantly plastic, so that it is readily possible to open the fire-protection bulkhead at any time and to re-position the cable.

Plasticines, which are also referred to as putties, are frequently used for this application. They generally consist of a liquid butyl rubber, plasticizers (paraffin oil, phthalates, adipates, etc.) and fillers, with a filler content of up to 80%. Sealing compositions, which contain only oils and fillers, for example, sealing compositions, which contain linseed oil and which then cross link slowly (putty), are also known. However, these Plasticines can be processed only with difficulty and, in particular, can hardly be introduced into cable bundles.

A further disadvantage of such sealing compositions consists therein that, in order to improve their fire-protection effect, only ablative, chemically intumescing or ceramizing fire-protection additives can be used. Accordingly, the permissible spectrum of such sealing compositions is limited to the area of sealing bushings for cables and steel pipes to prevent passage of smoke. If such sealing compositions were to be permitted for plastic pipes and steel pipes with organic insulation, they would have to develop an intumescing pressure, which is, however, not possible with these fire-protection additives. With such systems, it is not possible to use intumescing materials, which can be expanded physically, such as expanding graphite or vermiculite, since these physically intumescing fire-protection additives are pressure delicate, so that they would be destroyed and lose their activity during the production or incorporation into the plastic matrix under the shear forces occurring during these processes and lead to abrasion, which would result in undesirable contamination during the processing.

### OBJECT OF THE INVENTION

It is an object of the present invention to indicate a Plasticine for fire-protection applications, which has little tackiness, but makes adhesion to cables, concrete, metal, etc. possible, does not stick to the fingers when being processed by hand and can easily be removed once again and also contains those fire-protection additives, with which it is possible to meet the requirements for the fire protection of cables, plastic pipes and steel pipes with organic insulation in openings of buildings.

### SUMMARY OF THE INVENTION

It has turned out that this objective can be accomplished owing to the fact that that, as organic polymer in the matrix composition of the Plasticine, a mixture of an aqueous polymer dispersion and a low molecular weight, permanently plastic, liquid polymer is used, because, surprisingly, it has turned out that, with the help of such a matrix composition, also delicate, physically intumescing, fire-protection additives, such as expanding graphite and intumescing vermiculite, can be incorporated into the matrix composition without loss of activity and without destruction of the particles with formation of corresponding degradation products.

The object of the invention therefore is a permanently plastic Plasticine of claim 1. The dependent claims relate to preferred embodiments of this inventive object, to a method for the preparation of this Plasticine, as well as to its use.

The invention accordingly relates to a permanently plastic Plasticine for fire-protection applications, comprising a fire-protection additive and a matrix composition containing conventional auxiliary materials based on organic polymers, which is characterized in that the matrix composition represents a mixture of an aqueous polymer dispersion (A) and a low-molecular weight, permanently plastic, liquid polymer (B) in a ratio by weight of (A) to (B) of 6:1 to 1:2.5 and preferably of 4:3 to 3:4.

Due to the inventive use of a mixture of an aqueous polymer dispersion and the low-molecular weight, permanently plastic, liquid polymer, it is possible to produce a matrix composition, which has such a low viscosity, that the incorporation of additives, which are delicate to shear, namely of expanding graphite and vermiculite, becomes possible. The inventive, permanently plastic Plasticine can then be used directly as a sealing composition or also extruded as a kneaded material and dried and then used in the form of panels, strips or rods. The inventive Plasticine can be formulated without a plasticizer, does not become brittle and also does not release any undesirable components to the environment. It can be produced and processed very easily and inexpensively.

In accordance with a preferred embodiment, the inventive Plasticine in the aqueous polymer dispersion (A) contains at least one representative of the group comprising polyurethanes, polyvinyl acetates, polyvinyl ethers, polyvinyl propionates, polystyrenes, natural or synthetic rubbers, poly((meth)acrylates) and homopolymers and copolymers based on (meth)acrylates, acrylonitrile, vinyl esters, vinyl ethers, vinyl chloride and/or styrene, preferably, poly(alkyl methacrylates), poly(alkyl acrylates), poly(aryl methacrylates), poly(aryl acrylates) and/or copolymers thereof with n-butyl acrylate and/or styrene.

Preferably, for the preparation of the matrix composition, the aqueous polymer dispersion (A) has a water content of 5 to 60% by weight and preferably of 20 to 40% by weight, which, in combination with the liquid polymer (B), makes it possible to introduce also delicate, fire-protection additives into the Plasticine.

The aqueous polymer dispersion (A) preferably is contained in the matrix composition in such an amount, that the proportion of water in the finished Plasticine is 2 to 30% by weight and preferably 5 to 15% by weight, depending on the degree of drying.

In accordance with a further preferred embodiment, the inventive Plasticine contains, as liquid polymer (B), at least one representative of the group comprising polyurethanes, polyvinyl acetates, polyvinyl ethers, polyvinyl propionates, polystyrenes, natural or synthetic rubbers, poly((meth)acrylates) and homopolymers and copolymers based on (meth)acrylates, acrylonitrile, vinyl esters, vinyl ethers, vinyl chloride and/or styrene, preferably poly(alkyl methacrylate), poly(alkyl acrylate), poly(aryl methacrylate), poly(aryl acrylate) and/or copolymers thereof with n-butyl acrylate and/or styrene.

The low molecular weight, permanently plastic, liquid polymer (B) has a molecular weight, determined by the K value according to DIN ISO 1628-1, preferably of 100,000 to 8,000,000 and especially of 250,000 to 5,000,000.

Preferably, the low molecular weight, permanently plastic liquid polymer (B), as a 50% solution in ethyl acetate, has a viscosity, determined according to DIN ISO 3219 at 23° C., of 40 to 350 mPa×sec and preferably of 50 to 200 mPa×sec.

Preferably, as fire-protection additives (C), the Plasticine contains additives, which have ceramizing (C1) and/or ablative activity (C2) and are intumescing (C3) and/or flame inhibiting (C4).

Fire-protection additives with ceramizing activity (C1) are additives which, in the event of a fire, form a very solid ash from the inventive Plasticine without any change in volume. They may be glass-forming additives such as powdered glass, sintered glass, ammonium polyphosphate or borates; additives, which, in actual fact, do not have a ceramizing effect such as kaolin, clay and bentonite, as well as certain polymers with a high aromatic content, which tend to carbonize and, by so doing, support the sintering of the fillers. Preferably, the percentage of inorganic fillers, which sinter together with the additives, is high.

In accordance with a preferred embodiment of the invention, powdered glass, sintered glass, fiberglass, zinc borates, ammonium polyphosphates, kaolin, clay, bentonite and mixtures of these additives are used as additive (C1) with a ceramizing activity.

Pursuant to the invention, aluminum hydroxide, magnesium hydroxide, boehmite (AlOOH), zinc borate, calcium sulfate, colemanite, ulexite, boracite and mixtures thereof are used as additive with an ablative activity (C2), which are energy-consuming in the event of a fire, because they split off water or carbon dioxide and, by these means, reduce the burning rate of the material,

As intumescing, fire-protection additives (C3), the inventive Plasticine preferably contains physically intumescing fire-protection additives, particularly thermally expandable graphites, vermiculites and perlites, especially expanding graphite, which optionally has an onset temperature, which has been modified chemically by introducing certain intercalation compounds. The onset temperature is the temperature, at which the expansion process commences. These physically intumescing fire-protection additives have the advantage over chemically intumescing fire-protection additives, that they make possible a significantly higher expansion pressure and higher expansion volume so that, by bringing these fire-protection additives into the inventive Plasticine, the requirements, which fire-protection compositions for plastic pipes, plastic-insulated cables and cable bundles and steel pipes with organic insulation must meet, can be fulfilled

Aside from these preferred, physically intumescing fire-protection additives, the inventive Plasticine may also comprise chemically intumescing mixtures, which contain ammonium polyphosphate, melamine or derivatives thereof, especially melamine phosphate and melamine cyanurate, ethylenediamine phosphate, guanidine, hydrazine and tris-2-hydroxyethylene cyanurate and at least one source of carbon, preferably pentaerythritol.

As flame-inhibiting additives (C4), the inventive Plasticines may contain at least one representative of the group comprising red phosphorus, phosphorus compounds, especially triethyl phosphate, triphenyl phosphate, diphenylcresyl phosphate, diphenyl-2-ethylhexyl phosphate, tricresyl phosphate, tris(2-ethylhexyl) phosphate, halogenated phosphate esters, especially trichloroethyl phosphate, tris(2-chloroisopropyl) phosphate, tris(tribromophenyl) phosphate, trisbromoneopentyl phosphate and tris(2-chloroethyl) phosphate, cycloaliphatic bromine compounds, especially hexabromocyclododecane, aromatic bromine compounds, especially tris(tribromophenyl)-triazine, poly(pentabromobenzyl acrylate), octabromodiphenyl oxide, decabromodiphenyl oxide, brominated trimethylphenylindane and metal hydroxides, especially aluminum hydroxide or magnesium hydroxide, zinc borate, ammonium polyphosphate and antimony oxide.

In accordance with a preferred embodiment, the inventive Plasticine may contain water(D), stabilizers (E), pigments (F) and/or fillers (G) as conventional auxiliary materials.

As stabilizers (E), preferably fungicides, biocides, dispersing agents, anti-aging agents, Theological additives, lubricants, anti-freezing agents or mixtures thereof may be used.

As pigments (F), the inventive Plasticine may contain red iron oxide, brown iron oxide, yellow iron oxide, titanium dioxide, carbon black, zinc oxide, chromium oxides or mixtures thereof.

According to a further preferred embodiment of the invention, the Plasticine contains, as filler (G), an inorganic filler, selected from the group comprising the metal oxides, borates, carbonates, preferably chalk, silicates, kaolin, barium sulfate, talcum, powdered glass, iron oxide, titanium dioxide, silica, inorganic foams, preferably foamed expanded clay, foamed perlite and foamed vermiculite, and/or small hollow spheres of a silicate material or glass, reinforcing fillers, especially fiberglass, mineral fibers, ceramic fibers, wollastonite, highly dispersed silica and mixtures thereof.

In accordance with a further preferred embodiment, the above-defined Plasticine comprises
10 to 30% by weight and preferably 15 to 25% by weight of the aqueous polymer dispersion (A),
5 to 25% by weight and preferably 10 to 20% by weight of the low molecular weight, permanently plastic, liquid polymer (B),
2 to 50% by weight and preferably 5 to 35% by weight of the fire-protection additive (C),
2 to 30% by weight and preferably 5 to 15% by weight of water (D),
0.1 to 2.0% by weight and preferably 0.5 to 1.5% by weight of stabilizers (E),
0.1 to 2.0% by weight and preferably 0.5 to 1.5% by weight of pigment (F) and/or
15 to 60% by weight and preferably 16 to 20% by weight of fillers (G), in each case relative to the weight of the Plasticine and with the proviso that the amount of all the components does not exceed 100%.

In accordance with a further preferred embodiment, the inventive Plasticine contains:
2 to 20% by weight and preferably 5 to 12% by weight of the fire-protection additive (C1),
2 to 36% by weight and preferably 5 to 35% by weight of the fire-protection additive (C2)
5 to 35% by weight and preferably 10 to 30% by weight of the fire-protection additive (C3), and/or
1 to 20% by weight and preferably 0.5 to 5% by weight of the fire-protection additive (C4),
   in each case relative to the weight of the Plasticine and with the proviso that the total amount of the fire-protection additive (C) does not exceed 60% by weight of the Plasticine.

The inventive Plasticine is permanently plastic, which means that, if it is used as intended, it is not cured even after a prolonged period and, instead, can be detached readily once again from the site of application and used once more, without loss of the fire-protection effect of the physically intumescing additives present in the Plasticine. Preferably, it has a viscosity, determined by the needle penetration test according to DIN 515792, corresponding to a depth of penetration of the needle (at a total weight of 12.5 g, a penetration time of 5 seconds at 20° C.) of 3 to 40 mm and preferably of 3 to 20 mm, the higher depths of penetration occurring at a higher water content of the inventive Plasticine.

The inventive Plasticine may be present in the form of rods, strips or panels or, when the water content is higher but still within the ranges defined above, in cartridges and/or bags, from which, if it is to be used, it can be expelled under pressure and processed.

The object of the invention furthermore is a method for the preparation of the inventive Plasticine, which is characterized in that
a) a homogeneous mixture of the aqueous polymer dispersion (A), water and optionally one or more stabilizers (E) is formed,
b) the mixture is adjusted to a pH ranging from 8 to 9,
c) the low molecular weight, permanently plastic, liquid polymer (B) is mixed in,
d) optionally pigments (F), fillers (G) and optionally additives with ceramizing activity (C1), ablative activity (C2) and/or flame-inhibiting activity (C4) are incorporated and homogenized,
e) optionally the intumescing additive (C3) is added, at least one of the fire-protection additives C1 to C4 being incorporated, and the mixture is homogenized, optionally extruded and optionally dried.

Pursuant to the invention, it is essential that the drying in step e) be carried out at a temperature below 150° C., if a physically intumescing additives (C3), especially thermally expandable graphite, vermiculite and/or perlite, is contained in the Plasticine.

The object of the invention furthermore is the use of the above-defined Plasticine for sealing openings, cable and pipe bushings in walls, floors and/or ceilings, joints between ceiling parts and wall parts, between masonry openings and constructions, which are to be installed, such as window frames and door frames, between ceilings and walls and between exterior walls and curtaining facades of buildings for the purposes of thermal insulation and/or fire protection.

The following examples and comparison examples are to explain the invention further.

### Example 1

An inventive Plasticine is prepared from the following constituents,

| | |
|---|---|
| Aqueous acrylate polymer dispersion | 15 parts by weight |
| (water content of 37%, Acronal V271) | |
| Liquid acrylate polymer (Acronal A4) | 20 parts by weight |
| Water | 3 parts by weight |
| Chalk (filler G) | 25 parts by weight |
| Kaolin (filler G) | 14 parts by weight |
| Expanding graphite (intumescing additives C3) | 16 parts by weight |
| Ammonium polyphosphate (additive with | 6 parts by weight |
| ceramizing activity C1) | |
| Iron oxide (pigment F) | 0.4 parts by weight |
| Fungicide (Mergal S97) | 0.3 parts by weight |
| Dispersing agent (pigment dispersant E) | 0.3 parts by weight |
| | 100 parts by weight |

For preparing this Plasticine, the acrylate dispersion, the fungicide, the dispersing agent and the water are added to a mixing vessel, the pH is adjusted to a value of 8 to 9 with ammonia, the liquid acrylate polymer is mixed in, the fillers, the pigment and the ammonium polyphosphate are incorporated and the mixture is homogenized. The expanding graphite is then mixed in and the material is homogenized, the mixing and homogenizing being carried out in a planetary mixer.

Directly after it is mixed, the Plasticine obtained has the consistency of a silicone sealing composition and a total water content of 8.55%.

This composition can be brought into the desired form with suitable equipment (extruder or press) and dried at a temperature below 150° C., the material assuming the consistency of a sealing composition.

The Plasticine, obtained before the drying step, can also be filled directly into cartridges or bags and processed as a sealing composition.

The viscosity of the Plasticine, determined with the help of the DIN 515792 needle penetration test, is as follows:
depth of penetration of the needle before drying: 18.6 mm
depth of penetration of the needle after drying: 4.6 mm

### Example 2

A Plasticine, prepared by the procedure of Example 1 and containing a ceramizing, fire-protecting additive, is obtained using the following constituents:

| | |
|---|---|
| Acrylate dispersion (Acronal V271) | 13.0% by weight |
| Liquid polymer (Acronal A4) | 25.0% by weight |
| Water | 2.0% by weight |
| Stabilizers (fungicide, dispersant) | 0.6% by weight |
| Pigment (iron oxide, titanium oxide) | 0.4% by weight |
| Filler (chalk, kaolin 1:1) | 29.0% by weight |
| Filler (powdered quartz) | 18.0% by weight |
| Additive with ceramizing activity (zinc borate) | 6.0% by weight |
| Additive with ceramizing activity (ammonium | 6.0% by weight |
| polyphosphate) | |

The Plasticine, produced in this way, has a water content of 6.8% by weight.

### Example 3

An inventive Plasticine, containing a fire-protection additive with a ceramizing activity and a fire-protection additive, having an ablative effect, is prepared according to the procedure of Example 1 using the following constituents:

| | |
|---|---|
| Acrylate dispersion (Acronal V271) | 13.0% by weight |
| Liquid polymer (Acronal A4) | 25.0% by weight |
| Water | 2.0% by weight |
| Stabilizers (fungicide, dispersant) | 0.6% by weight |
| Pigment (iron oxide, titanium oxide) | 0.4% by weight |
| Filler (chalk, kaolin 1:1) | 20.0% by weight |
| Additive with ceramizing activity | 6.0% by weight |
| (zinc borate) | |
| Additive with ablative activity | 33.0% by weight |
| (aluminum hydroxide) | |

The Plasticine, produced in this way, has a water content of 6.8% by weight.

### Example 4

An inventive Plasticine, containing a chemically intumescing fire-protection additive, is produced using the procedure of Example 1 and the following constituents:

| | |
|---|---|
| Acrylate dispersion (Acronal V271) | 13.0% by weight |
| Liquid polymer (Acronal A4) | 25.0% by weight |
| Water | 2.0% by weight |
| Stabilizers (fungicide, dispersant) | 0.6% by weight |
| Pigment (iron oxide, titanium oxide) | 0.4% by weight |
| Filler (chalk, kaolin 1:1) | 23.0% by weight |
| Filler (powdered quartz) | 10.0% by weight |
| Chemically intumescing mixture (ammonium | 26.0% by weight |
| polyphosphate + melamine + dipentaerythritol 3:3:1) | |

The Plasticine, produced in this way, has a water content of 6.8% by weight.

### Example 5

For comparison of the surprising, intumescing effect, which can be achieved with the inventive Plasticine, a conventional sealing composition, based on butyl rubber and containing a chemically intumescing fire-protection additive and such a sealing composition, into which 16% of expanding graphite has been incorporated, is compared with the inventive Plasticine of Example 1 with an expanding graphite content of 16%, with respect to the expansion behavior upon being heated to 600° C.

The foam height was measured here according to the guidelines for intumescing building materials of the DIBT, that is, after the test sample had being heated for 30 minutes at 600° C. under a load of 5 g/cm². The results obtained are given in the following Table.

| | | Butyl Plasticine | |
|---|---|---|---|
| | Butyl Plasticine | with 16% | Inventive |
| | chemically | expanding | Plasticine |
| | intumescing | graphite | of Example 1 |
| Foam height | 5 mm | 11 mm | 45 mm |
| at 600° C. | (from a starting | (from a starting | (from a starting |
| | thickness | thickness of | thickness |
| | of 5 mm) | 5 mm) | of 5 mm) |
| Expansion | 0 | 2 | 9 |
| factor | | Graphite largely | |
| | | destroyed | |

It is evident that, with the conventional sealing compound based on butyl rubber, which contains only a chemically intumescing fire-protection additive, no expansion whatsoever is achieved upon heating to 600° C. If this conventional butyl rubber Plasticine is treated with 16% by weight of expanding graphite, a foam height of only 11 mm is obtained, since the graphite is largely destroyed as it is being incorporated.

In contrast to the above, the inventive Plasticine has a foam height of 45 mm, which corresponds to an expansion by a factor of 9.

It is therefore shown that the inventive Plasticine, due to the inventive use of a matrix composition of an aqueous polymer dispersion and of a low molecular weight, permanently plastic, liquid polymer, brings about a dramatic improvement in the expansion behavior.

1. Permanently plastic Plasticine for fire-protection applications, comprising a matrix composition based on organic polymers and containing a fire-protection additive and conventional auxiliary materials, characterized in that the matrix composition represents a mixture of an aqueous polymer dispersion (A) and a low-molecular weight, permanently plastic, liquid polymer (B) in a ratio by weight of (A) to (B) of 6:1 to 1:2.5.

2. The Plasticine of claim 1, characterized in that the aqueous polymer dispersion (A), as polymer, contains at least one representative of the group comprising polyurethanes, polyvinyl acetates, polyvinyl ethers, polyvinyl propionates, polystyrenes, natural or synthetic rubbers, poly((meth)acrylates) and homopolymers and copolymers based on (meth)acrylates, acrylonitrile, vinyl esters, vinyl ethers, vinyl chloride and/or styrene.

3. The Plasticine of claim 2, characterized in that the aqueous polymer dispersion (A), as polymer, contains poly(alkyl methacrylates), poly(alkyl acrylates), poly(aryl methacrylates), poly(aryl acrylates) and/or copolymers thereof with n-butyl acrylate and/or styrene.

4. The Plasticine of claim 1, characterized in that the aqueous polymer dispersion (A) has a water content of 3 to 60% by weight and preferably of 20 to 40% by weight.

5. The Plasticine of claim 1, characterized in that the aqueous polymer dispersion (A) is contained in the matrix composition in such an amount, that a water content in the Plasticine of 2 to 30% by weight and preferably of 5 to 15% by weight results.

6. The Plasticine of claim 1, characterized in that it contains, as liquid polymer (B), at least one representative of the group comprising polyurethanes, polyvinyl acetates, polyvinyl ethers, polyvinyl propionates, natural or synthetic rubbers, poly(meth)acrylates) and homopolymers and copolymers based on (meth)acrylates, acrylonitrile, vinyl esters, vinyl ethers, vinyl chloride and/or styrene.

7. The Plasticine of claim 6, characterized in that it contains, as liquid polymer (B), poly(alkyl methacrylate), poly(alkyl acrylate), poly(aryl methacrylate), poly(aryl acrylate) and/or copolymers thereof with n-butyl acrylate and/or styrene.

8. The Plasticine of claim 6, characterized therein that the low molecular weight, permanently plastic, liquid polymer (B) has a molecular weight of 100,000 to 8,000,000 and preferably of 250,000 to 5,000,000.

9. The Plasticine of claim 6, characterized in that the low molecular weight, permanently plastic, liquid polymer (B) has a viscosity of 40 to 350 mPa×sec and preferably of 50 to 200 mPa×sec.

10. The Plasticine of claim 1, characterized in that it contains additives with a ceramizing effect (C1), an ablative effect (C2), an intumescing effect (3) and/or a flame-inhibiting effect (C4) as fire-protection additives.

11. The Plasticine of claim 10, characterized in that, as additive (C1) with a ceramizing effect, it contains at least one representative of the group comprising powdered glass, sintered glass, fiberglass, zinc borate, ammonium polyphosphate, kaolin, clay and bentonite.

12. The Plasticine of claim 10, characterized in that it contains, as additive with ablative activity (C2), at least one representative of the group comprising aluminum hydroxide, magnesium hydroxide, boehmite (AlOOH), zinc borate, calcium sulfate, colemanite, ulexite, boracite.

13. The Plasticine of claim 10, characterized in that it contains, as additive having intumescing activity (3), at least one representative of the group, which comprises the thermally expandable graphites, vermiculites and perlites, sodium borosilicates, encapsulated sodium borosilicates, and chemically intumescing mixtures, which contain ammonium polyphosphate, melamine or derivatives thereof, particularly melamine phosphate and melamine cyanurate, ethylenediamine phosphate, guanidine, hydrazine and tris-2-hydroxyethyl cyanurate and at least one source of carbon, preferably, pentaerythritol.

14. The Plasticine of claim 10, characterized in that it contains, as additive with flame-inhibiting properties (C4), at least one representative of the group comprising red phosphorous, phosphorous compounds, especially triethyl phosphate, triphenyl phosphate, diphenylcresyl phosphate, diphenyl-2-ethylhexyl phosphate, tricresyl phosphate, tris(2-ethylhexyl) phosphate, halogenated phosphate esters, especially trichloroethyl phosphate, tris(2-chloroisopropyl) phosphate, tris(tribromophenyl) phosphate, trisbromoneopentyl phosphate and tris(2-chloroethyl) phosphate, (cyclo)aliphatic bromine compounds, especially hexabromocyclo-dodecane, aromatic bromine compounds, especially tris(tribromophenyl)-triazine, poly(pentabromobenzyl acrylate), octabromodiphenyl oxide, decabromodiphenyl oxide, brominated trimethylphenylindane, and metal hydroxides, especially aluminum hydroxide or magnesium hydroxide, zinc borate, ammonium polyphosphate and antimony monoxide.

15. The Plasticine of claim 1, characterized in that it contains water (D), stabilizers (E), pigments (F) and/or fillers (G) as conventional auxiliary materials.

16. The Plasticine of claim 15, characterized in that it contains fungicides, biocides, dispersing agents, anti-aging materials, Theological additives, lubricants, antifreeze materials or mixtures thereof as stabilizers (E).

17. The Plasticine of claim 15, characterized in that it contains red iron oxide, titanium dioxide, carbon black, zinc oxide, chromium oxide or mixtures thereof as pigment (F).

18. The Plasticine of claim 15, characterized in that it contains an inorganic filler selected from the metal oxides, borate, carbonates, preferably chalk, silicates, kaolin, barium sulfate, talcum, powdered glass, iron oxide, titanium dioxide, silica, inorganic foams, preferably foamed expanded clay, foamed perlite and foamed vermiculite and/or hollow small spheres of silicate material or glass, reinforcing fillers, especially fiberglass, mineral fibers, ceramic fibers, wollastonite, highly dispersed silica and mixtures thereof as filler (G).

19. The Plasticine of claim 1, characterized in that it contains 10 to 30% by weight and preferably 15 to 25% by weight of the aqueous polymer dispersion (A),
5 to 25% by weight and preferably 10 to 20% by weight of the low molecular weight, permanently plastic, liquid polymer (B),
2 to 50% by weight and preferably 5 to 35% by weight of the fire-protection additive (C),
2 to 30% by weight and preferably 5 to 15% by weight of water (D),
0.1 to 2.0% by weight and preferably 0.5 to 1.5% by weight of stabilizers (E),
0.1 to 2.0% by weight and preferably 0.5 to 1.5% by weight of pigment (F) and/or
15 to 60% by weight and preferably 16 to 20% by weight of fillers (G), in each case relative to the weight of the Plasticine and with the proviso that the amount of all the components does not exceed 100%.

20. The Plasticine of claim 19, characterized in that it contains 2 to 20% by weight and preferably 5 to 12% by weight of the fire-protection additive (C1),
2 to 36% by weight and preferably 5 to 35% by weight of the fire-protection additive (C2)
5 to 35% by weight and preferably 10 to 30% by weight of the fire-protection additive (C3), and/or
1 to 20% by weight and preferably 0.5 to 5% by weight of the fire-protection additive (C4),
in each case relative to the weight of the Plasticine and with the proviso that the total amount of the fire-protection additive (C) does not exceed 60% by weight of the Plasticine.

21. The Plasticine of claim 1, characterized in that it has a viscosity, measured by the needle penetration test of DIN 515792, corresponding to a depth of penetration of the needle of 3 to 40 mm and preferably of 3 to 20 mm.

22. The Plasticine of claim 1, characterized in that it is present in the form of rods, strips or panels or in cartridges and/or bags, from which it can be expelled using pressure.

23. Method for the preparation of the Plasticine, comprising a matrix composition based on organic polymers and containing a fire-protection additive and conventional auxiliary materials, characterized in that the matrix composition represents a mixture of an aqueous polymer dispersion (A) and a low-molecular weight, permanently plastic, liquid polymer (B) in a ratio by weight of (A) to (B) of 6:1 to 1:2.5, characterized in that a) a homogeneous mixture of the aqueous polymer dispersion (A), water and optionally one or more stabilizers (E) is formed,
b) the mixture is adjusted to a pH ranging from 8 to 9,
c) the low molecular weight, permanently plastic, liquid polymer (B) is mixed in,
d) optionally pigments (F), fillers (G) and optionally additives with ceramizing activity (1), ablative activity (C2) and/or flame-inhibiting activity (C4) are incorporated and homogenized,
e) optionally the intumescing additive (C3) is added, at least one of the fire-protection additives C1 to C4 being incorporated, and the mixture is homogenized, optionally extruded and optionally dried.

24. The method of claim 23, characterized in that the drying step e) is carried out at a temperature below 150° C. when an intumescing additives (C3) is contained in the Plasticine.

25. The Plasticine of claim 1 wherein the ratio by weight of (A) to (B) is 4:3 to 3:4.
